(19) United States
(12) Patent Application Publication
(10) Pub. No.: US 2007/0141280 A1
(43) Pub. Date: Jun. 21, 2007

(54) SUBSTRATE CARRIER HAVING AN INTERIOR LINING

(75) Inventor: MICHAEL RICE, Pleasanton, CA (US)

Correspondence Address: DUGAN & DUGAN, PC, 55 SOUTH BROADWAY, TARRYTOWN, NY, 10591, US

(73) Assignee: APPLIED MATERIALS, INC.

(21) Appl. No.: 11/554,853

(22) Filed: Oct. 31, 2006

Related U.S. Application Data
(60) Provisional application No. 60/751,105, filed on Dec. 16, 2005.

(51) Int. Cl. B28B 11/00

(52) U.S. Cl. 428/34.4

(57) ABSTRACT

The invention provides apparatus and manufacturing methods for a liner adapted to enclose a space within a substrate carrier and further adapted to prevent gas from reaching the enclosed space. The liner may be removable from the substrate carrier. The liner may be self-supporting and/or the liner may be supported by interior walls of the substrate carrier. The liner may be adapted to absorb particles to prevent contamination of substrates stored in the substrate carrier. The liner may be an interior glass coating in a substrate carrier that prevents outgassing from the substrate carrier. Numerous other aspects are disclosed.

### RELATED APPLICATIONS

The present application claims priority to U.S. Provisional Patent Application Ser. No. 60/751,105, filed on Dec. 16, 2005 and entitled “SUBSTRATE CARRIER HAVING AN INTERIOR LINING,” which is hereby incorporated by reference herein for all purposes.

### FIELD OF THE INVENTION

The present invention relates to electronic device manufacturing and, more particularly, to a substrate carrier having an interior lining.

### BACKGROUND

It is generally preferable to protect substrates (e.g., patterned or unpatterned semiconductor wafers, glass panels, polymer substrates, reticules, masks, glass plates or the like) from exposure to any potential contaminating particles. Thus, such substrates may be stored in air tight containers. However, the substrates must typically be transported to different process tools within an electronic device manufacturing facility. Conventional substrate carriers may not provide air tight compartments. Thus, what is needed are methods and apparatus for transporting substrates in sealable containers as well as systems and methods for accessing the substrates without exposing the substrates to potential contaminating particles.

### SUMMARY OF THE INVENTION

In some aspects, the present invention provides a substrate carrier that includes a substrate carrier body, wherein the substrate carrier body defines an interior region bounded by an inner top wall, an inner bottom wall and a plurality of inner side walls; a substrate carrier door coupled to the substrate carrier body, wherein the substrate carrier door has an inner wall which further defines the interior region; and a lining along at least a portion of the inner walls of the substrate carrier body and the inner wall of the substrate carrier door adapted to prevent permeation of a gas into and out of the interior region of the substrate carrier.

In other aspects, the present invention provides a substrate carrier lining that includes a top portion adapted to be positioned along an inner top wall of the substrate carrier defined by a substrate carrier body; a bottom portion adapted to be positioned along a bottom wall of the substrate carrier defined by the substrate carrier body; a plurality of side portions adapted to be positioned along corresponding inner side walls of the substrate carrier defined by the substrate carrier body; and an additional portion adapted to be positioned along an inner wall of a door of the substrate carrier. The portions of the lining may be adapted to prevent permeation of a gas into and out of the interior region of the substrate carrier.

In yet other aspects, the present invention provides a method of manufacturing a substrate carrier that includes forming a substrate carrier body, wherein the substrate carrier body defines an interior region bounded by an inner top wall, an inner bottom wall and a plurality of inner side walls; forming a substrate carrier door, wherein the substrate carrier door has an inner wall which further defines the interior region; and forming a lining along at least a portion of the inner walls of the substrate carrier body and the inner wall of the substrate carrier door. The lining may be adapted to prevent permeation of a gas into and out of the interior region of the substrate carrier.

In still other aspects, the present invention provides an apparatus that includes a substrate carrier and a liner adapted to enclose a space within the substrate carrier and further adapted to prevent gas from reaching the enclosed space. The liner may be removable from the substrate carrier. The liner may be self-supporting and/or the liner may be supported by interior walls of the substrate carrier. The liner may be adapted to absorb particles to prevent contamination of substrates stored in the substrate carrier.

Other features and aspects of the present invention will become more fully apparent from the following detailed description, the appended claims and the accompanying drawings.

### BRIEF DESCRIPTION OF THE DRAWINGS

FIG. 1 is a side-cross-sectional view of an exemplary substrate carrier in accordance with an embodiment of the present invention.

FIG. 2 is a side-cross-sectional view of a second exemplary substrate carrier in accordance with an embodiment of the present invention.

### DETAILED DESCRIPTION

The present invention relates to electronic device manufacturing and, more particularly, to a substrate carrier, such as a front opening unified pod (FOUP) or the like, having an interior lining. The substrate carrier may be used to house and transport one or more substrates such as patterned or unpatterned semiconductor wafers, glass panels, polymer substrates, reticules, masks, glass plates or the like.

In accordance with the present invention, a substrate carrier is provided that has an interior lining. As used herein, the term “lining” includes a lining, a liner, a coating, or the like, whether self-supporting, insertable/removable, free-standing, one piece or multiple piece construction, mounted to the interior walls of the carrier, and/or applied to the interior walls of the carrier. In other words, the lining may be located on one or more interior walls of the substrate carrier or may be a separate structure for insertion into the substrate carrier. The lining may serve to prevent the outgassing, or the permeation of, a gas and/or the transport of particulates from the substrate carrier's interior region, through the walls of the substrate carrier, and into the environment surroundings of the substrate carrier. The interior lining may also serve to prevent contamination of the substrate carrier's interior region, and any substrates located within the substrate carrier, which may result from gas or contaminants entering the substrate carrier's interior from the substrate carrier walls and/or the environment that surrounds the substrate carrier.

In an exemplary embodiment, the lining may be a sheet or a material which is placed on, coupled to, or formed on, the inner walls and/or interior components of the substrate carrier. For example, the lining may be a gas impermeable material such as a glass sheet, a glass coating or the like. In another exemplary embodiment, the lining may be a dielectric material such as silicon nitride, silicon dioxide, etc., or any other sheet, material or substance which prevents or substantially prevents the permeation of a gas and/or transport of particulates through a wall of the substrate carrier.

In another exemplary embodiment, the lining may be an absorption barrier that absorbs a gas and/or particulates, while, at the same time, preventing their permeation through the same. Examples of absorption materials include desiccant materials or desiccant-like materials that have an affinity for particular gasses/vapors. A desiccant material may be, for example, “preconditioned” as the selective desiccant loads up with material. A replaceable lining additionally or alternatively may be used. In general, the lining may be reconditioned, reapplied and/or replaced.

The substrate carrier of the present invention may be capable of holding and/or transporting any number of substrates. In this regard, the inventive substrate carrier may hold and/or transport a single substrate or a plurality of substrates.

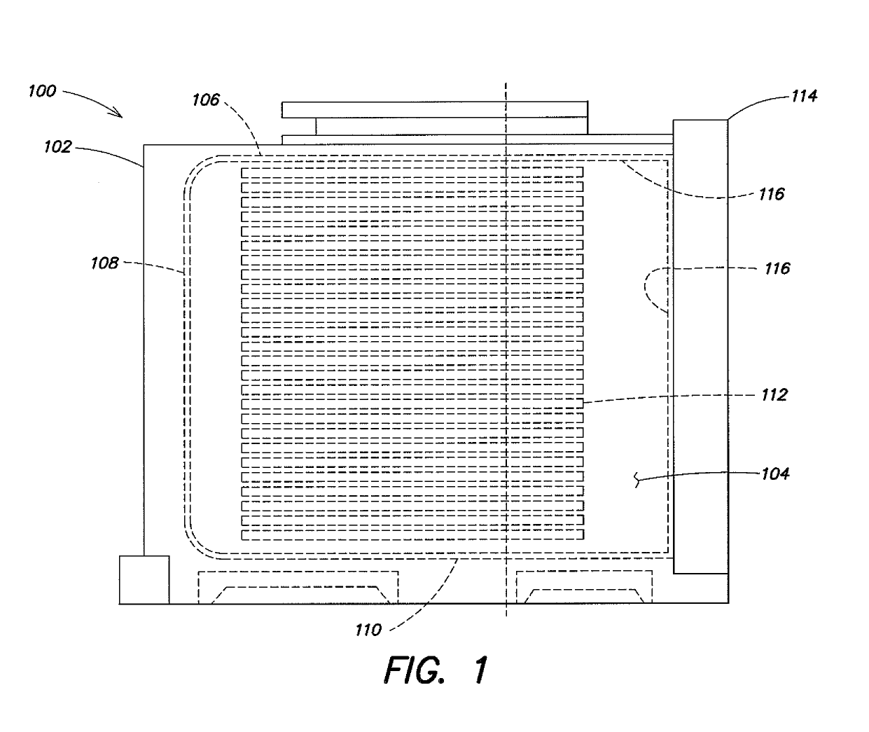

FIG. 1 is a side cross-sectional view of an exemplary substrate carrier of the present invention which is designated generally by the reference numeral 100. With reference to FIG. 1, the substrate carrier 100 includes a substrate carrier body 102 having and defining an interior region 104. The interior region 104 may be bounded by and defined by a top interior wall 106, interior side walls 108 and an interior bottom wall 110. The substrate carrier 100 may also contain substrates, or devices for holding or supporting the same, designated generally by the reference numeral 112. In an exemplary embodiment, the substrate carrier 100 may be equipped or adapted to hold and/or transport any number of substrates. With reference once again to FIG. 1, the substrate carrier 100 also includes a substrate carrier door 114, as shown.

In the exemplary embodiment of FIG. 1, the substrate carrier 100 includes a lining 116 on the interior top wall 106, each of the interior side walls 108 and the interior bottom wall 110, as shown. The lining 116 may be placed on, located along, or formed on or along all or a portion of a wall or walls, including any corner regions. Likewise, the lining 116 may be placed on, located along, or formed on or along a component of the substrate carrier located adjacent to a respective wall or walls.

The lining 116 also may be placed on, located along, or formed on or along all or a portion of the interior side of the substrate carrier door 114 or a component attached to the interior side of the substrate carrier door 114.

The lining 116 may be a gas impermeable material such as a glass sheet or a glass coating. In another exemplary embodiment, the lining 116 may be a silicon nitride sheet or coating, a silicon dioxide sheet or coating, or another dielectric material. In general, the lining 116 may be any suitable material or coating which may protect against outgassing and/or which may serve as a protective barrier to prevent the permeation of a gas and/or particulates into and/or from the interior region 104 of the substrate carrier 100.

The lining 116 may also be, and may serve as, an absorption barrier that absorbs a gas and/or particulates so as to prevent their permeation through the same. Exemplary absorptive materials suitable for the lining 116 include desiccant or desiccant-like materials, or the like. In this manner, the permeation of a gas or particulates into and/or from the inner region 104 of the substrate carrier 100 may be prevented or, at the very least, substantially minimized.

The lining 116 may have any thickness sufficient to achieve substantial minimization of gas and/or particulate permeability. In an exemplary embodiment, the lining 116 may have a thickness ranging from about 1 micron to about 50 microns, although other thicknesses may be used, as may non-uniform and/or varying thicknesses.

The lining 116 may be applied in any appropriate manner to the interior walls of the substrate carrier body 102 and the substrate carrier door 114. The lining 116 may, for example, be a sheet material which may be placed on, glued onto, or otherwise coupled to the respective interior walls or components of the substrate carrier 100 (including the door 114). Alternatively, the lining 116 may be applied by spray coating, by covering the interior walls or components with a liquid coating which may dry as a solid sheet of material or by any other suitable technique. In another exemplary embodiment, the lining 116 may be vapor deposited onto the respective inner walls or components of the substrate carrier 100. In general, the lining 116 may be applied or installed in any appropriate form (e.g., solid, liquid, gas, etc.) and/or in any appropriate manner.

The lining 116 may serve to prevent any gas or particulates from permeating from the interior region 104 of the substrate carrier 100, to and/or through the respective walls 106, 108 and 110 and/or the substrate carrier door 114, and into the environment surrounding the substrate carrier 100. The lining 116 may also serve to prevent contaminants from passing from the environment surrounding the substrate carrier 100 or from the components of the substrate carrier itself into the substrate carrier's interior region 104.

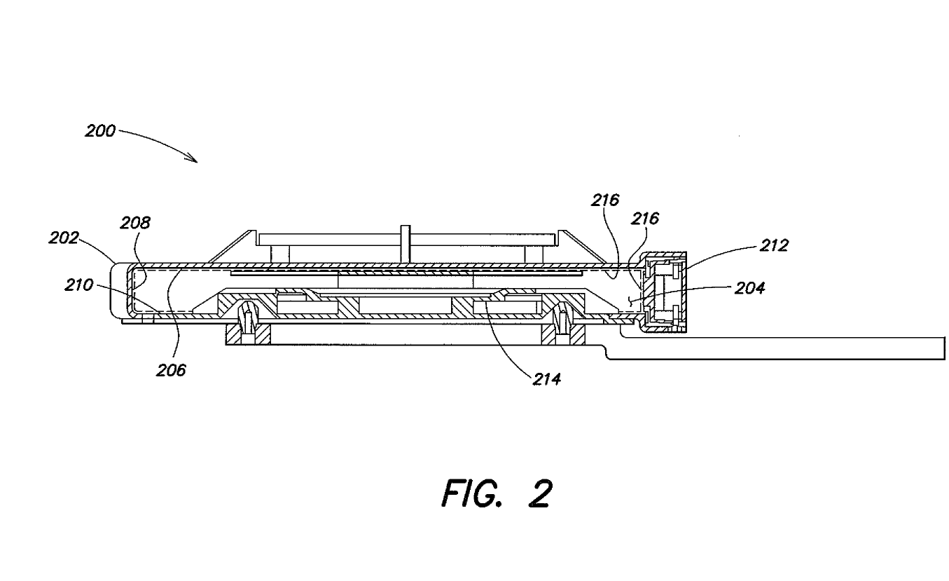

Although FIG. 1 shows an exemplary substrate carrier adapted to hold a plurality of substrates, in another exemplary embodiment, the inventive substrate carrier may be designed or adapted to hold only a single substrate, or a few substrates, as shown in FIG. 2.

FIG. 2 is a side cross-sectional view of another exemplary substrate carrier provided in accordance with the present invention which is designated generally by the reference numeral 200. With reference to FIG. 2, the substrate carrier 200 includes a substrate carrier body 202 having an interior region 204. The interior region 204 is bounded by a top interior wall 206, interior side walls 208 and an interior bottom wall 210.

The substrate carrier 200 also includes a substrate carrier door 212 and a substrate support device 214, which, in an exemplary embodiment, may be situated on, or attached to, the interior bottom wall 210.

The substrate carrier 200 also includes a lining 216 on the interior top wall 206, each of the interior side walls 208 and the interior bottom wall 210, as shown.

In the exemplary embodiment of FIG. 2, the lining 216 may be placed on or along, located on, or formed on or along all or a portion of a wall or walls or other interior component, including any corner regions, of the substrate carrier 200. For example, the support device 214, or a portion of the same, may include the lining 216.

The substrate carrier 200 also may include the lining 216 on all or a portion of the interior side of the substrate carrier door 212.

The lining 216 may be a gas impermeable material such as a glass sheet or a glass coating. In another exemplary embodiment, the lining 216 may be a silicon nitride sheet or coating, a silicon dioxide sheet or coating, or another dielectric material. In general, the lining 216 may be any suitable material or coating which may protect against outgassing and/or which may serve as a protective barrier to prevent the permeation of a gas and/or particulates into and/or from the interior region 204 of the substrate carrier 200.

The lining 216 may also be, and may serve as, an absorption barrier that absorbs a gas and/or particulates so as to prevent their permeation through the same. Exemplary absorptive materials suitable for the lining 216 include desiccant or desiccant-like materials or the like. In this manner, the permeation of a gas or particulates into and/or from the inner region 204 of the substrate carrier 200 may be prevented or, at the very least, substantially minimized.

The lining 216 of FIG. 2, like the lining 116 of FIG. 1, may have any desired thickness. In one embodiment, the lining 216 may have a thickness ranging from about 1 micron to about 50 microns. Also, like the lining 116 of FIG. 1, the lining 216 may be applied in any appropriate manner in a solid, liquid or gas phase.

The lining 216 may serve to prevent any gas and/or particulates from permeating into or from the interior region 204 of the substrate carrier 200, to and/or through the respective walls 206, 208 and 210 and/or the substrate carrier door 212.

In some embodiments, the lining 116, 216 may serve to prevent the material used to form the body or shell of the substrate carrier 100, 200 and/or the door 114, 212 itself from outgassing and contaminating a substrate stored in the substrate carrier 100, 200. Additionally, the lining 116, 216 may act as a protective lining to prevent, for example, reactive species emitted or outgassed from a substrate from attacking the substrate carrier material. The lining 116, 216 may also allow the methods and/or materials with which substrate carriers are constructed to be altered. For example, a less costly and/or more easily manufacturable material may be used for the substrate carriers than would otherwise be unacceptable without the lining (e.g., the lining may provide the necessary barrier or isolation between the substrate(s) and the substrate carrier material).

While the present invention has been described and illustrated in various exemplary embodiments, such descriptions are merely illustrative of the present invention and are not to be construed to be limitations thereof. In this regard, the present invention encompasses any and all modifications, variations and/or alternate embodiments within the scope of the present invention being limited only by the claims which follow.

The invention claimed is:

1. A substrate carrier, comprising:
a substrate carrier body, wherein the substrate carrier body defines an interior region bounded by an inner top wall, an inner bottom wall and a plurality of inner side walls;
a substrate carrier door coupled to the substrate carrier body, wherein the substrate carrier door has an inner wall which further defines the interior region; and
a lining along at least a portion of the inner walls of the substrate carrier body and the inner wall of the substrate carrier door adapted to prevent permeation of a gas into and out of the interior region of the substrate carrier.

2. The substrate carrier of claim 1, wherein the lining comprises at least one of silicon nitride and silicon dioxide.

3. The substrate carrier of claim 1, wherein the lining has a thickness ranging from about 1 micron to about 50 microns.

4. The substrate carrier of claim 1, wherein the lining is further adapted to prevent outgassing from the interior region of the substrate carrier.

5. The substrate carrier of claim 1, wherein the lining is further adapted to prevent transport of particles into the substrate carrier from the surrounding environment and from the interior region of the substrate carrier to the surrounding environment.

6. The substrate carrier of claim 1, wherein the lining is formed from an impermeable material.

7. The substrate carrier of claim 6, wherein the lining is a glass sheet or a glass coating.

8. The substrate carrier of claim 1, wherein the lining is formed from a dielectric material.

9. The substrate carrier of claim 1, wherein the lining is further adapted to absorb particles from the interior region of the substrate carrier or from the surrounding environment.

10. The substrate carrier of claim 9, wherein the lining is formed from a desiccant material or desiccant-like material.

11. The substrate carrier of claim 1, wherein the lining is adapted to be at least one of reconditioned, reapplied and replaced.

12. The substrate carrier of claim 1, wherein the substrate carrier is adapted to store one substrate.

13. The substrate carrier of claim 1, wherein the substrate carrier is adapted to store more than one substrate.

14. A substrate carrier lining, comprising:
a top portion adapted to be positioned along an inner top wall of the substrate carrier defined by a substrate carrier body;
a bottom portion adapted to be positioned along a bottom wall of the substrate carrier defined by the substrate carrier body;
a plurality of side portions adapted to be positioned along corresponding inner side walls of the substrate carrier defined by the substrate carrier body; and
an additional portion adapted to be positioned along an inner wall of a door of the substrate carrier;
wherein the portions of the lining are adapted to prevent permeation of a gas into and out of the interior region of the substrate carrier.

15. The substrate carrier lining of claim 14, wherein one or more of the portions of the lining comprise at least one of silicon nitride and silicon dioxide.

16. The substrate carrier lining of claim 14, wherein one or more of the portions of the lining have a thickness ranging from about 1 micron to about 50 microns.

17. The substrate carrier lining of claim 14 wherein one or more of the portions of the lining are further adapted to prevent outgassing from the interior region of the substrate carrier.

18. The substrate carrier lining of claim 14 wherein one or more of the portions of the lining are further adapted to prevent transport of particles into the substrate carrier from the surrounding environment and from the interior region of the substrate to the surrounding environment.

19. The substrate carrier lining of claim 14 wherein one or more of the portions of the lining are formed from an impermeable material.

20. The substrate carrier lining of claim 19 wherein one or more of the portions of the lining are glass sheets or glass coatings.

21. The substrate carrier lining of claim 14 wherein one or more of the portions of the lining are formed from a dielectric material.

22. The substrate carrier lining of claim 14 wherein one or more of the portions of the lining are further adapted to absorb particles from the interior region of the substrate carrier or from the surrounding environment.

23. The substrate carrier lining of claim 22 wherein one or more of the portions of the lining are formed from a desiccant material or desiccant-like material.

24. The substrate carrier lining of claim 14 wherein one or more of the portions of the lining are adapted to be at least one of reconditioned, reapplied and replaced.

25. A method of manufacturing a substrate carrier, comprising:
forming a substrate carrier body, wherein the substrate carrier body defines an interior region bounded by an inner top wall, an inner bottom wall and a plurality of inner side walls;
forming a substrate carrier door, wherein the substrate carrier door has an inner wall which further defines the interior region; and
forming a lining along at least a portion of the inner walls of the substrate carrier body and the inner wall of the substrate carrier door;
wherein the lining is adapted to prevent permeation of a gas into and out of the interior region of the substrate carrier.

26. The method of claim 25 wherein forming the substrate carrier body includes forming the substrate carrier body from a cheaper or more manufacturable material than that employed for a conventional substrate carrier body.

27. The method of claim 25 wherein forming the lining along at least a portion of the inner walls of the substrate carrier body and the inner wall of the substrate carrier door includes gluing, spraying or vapor depositing the lining along at least a portion of the inner walls of the substrate carrier body and the inner wall of the substrate carrier door.

28. An apparatus comprising:
a substrate carrier; and
a liner adapted to enclose a space within the substrate carrier and further adapted to prevent gas from reaching the enclosed space.

29. The apparatus of claim 28 wherein the liner is removable from the substrate carrier.

30. The apparatus of claim 28 wherein the liner is self-supporting.

31. The apparatus of claim 28 wherein the liner is supported by interior walls of the substrate carrier.

32. The apparatus of claim 28 wherein the liner is adapted to absorb particles to prevent contamination of substrates stored in the substrate carrier.
